(19) United States
(12) Patent Application Publication
(10) Pub. No.: US 2016/0063404 A1
(43) Pub. Date: Mar. 3, 2016

(54) UNIVERSAL BACK OFFICE WORKFLOW

(71) Applicant: Bank of America Corporation, Charlotte, NC (US)

(72) Inventors: Anthony J. Doerr, Downingtown, PA (US); Thomas M. McCormick, Phoenix, AZ (US); Daniel S. Penne, Wynnewood, PA (US); Kevin A. Mayes, Wilmington, DE (US); Joseph W. McLean, Clayton, DE (US)

(21) Appl. No.: 14/468,965

(22) Filed: Aug. 26, 2014

(51) Int. Cl. G06Q 10/06

(52) U.S. Cl. CPC G06Q 10/0633

(57) ABSTRACT

According to one embodiment of the present disclosure, a system includes a workflow engine for performing a claim processing workflow. The workflow includes: a notice workflow that initiates processing of a claim; an investigation workflow that investigates the claim; a recovery workflow that recovers a value associated with the claim; and a resolution workflow that concludes processing of a claim. The notice, investigation, recovery, and resolution workflows each comprise preconditions common among the plurality of organizations. The notice, investigation, recovery, and resolution workflows each comprise customization points. The customization points are configured to perform organization-specific workflow actions. The system also includes a customized workflow module associated with one of the plurality of organizations and configured to perform an organization-specific claims processing workflow. The customized workflow module communicates, to the workflow engine, organization-specific actions to be performed at the customization points of each of the notice, investigation, recovery, and resolution workflows.

### TECHNICAL FIELD

This disclosure relates generally to back office workflows, and more particularly to a universal back office workflow based on a normalized workflow abstraction.

### BACKGROUND

An organization, such as a financial institution, may implement multiple workflows across different parts of an organization to accomplish similar tasks. For example, a financial institution may implement workflows to handle claims processing, such as fraudulent transaction or disputed transaction claims. Within the financial institution, a sub-organization responsible for credit card products may implement a claims processing workflow, a sub-organization responsible for debit card products may implement a different claims processing workflow, and a sub-organization responsible for checking products may implement yet a third claims processing workflow. Maintaining systems that support these organization-specific workflows often requires duplicated effort, which is inefficient, and may lead to inconsistent implementations.

### SUMMARY OF EXAMPLE EMBODIMENTS

In accordance with the present disclosure, disadvantages and problems associated with multiple partially redundant workflows may be reduced or eliminated.

According to one embodiment of the present disclosure, a system includes a workflow engine for performing a normalized claim processing workflow normalized over a plurality of organizations. The normalized claim processing workflow comprises: a notice workflow that initiates processing of a claim; an investigation workflow that investigates the claim; a recovery workflow that recovers a value associated with the claim; and a resolution workflow that concludes processing of a claim. The notice, investigation, recovery, and resolution workflows each comprise preconditions common among the plurality of organizations. The preconditions are configured to perform a portion of the normalized claims processing workflow common among the plurality of organizations. The notice, investigation, recovery, and resolution workflows each comprise customization points. The customization points are configured to perform organization-specific workflow actions. The system also includes a first customized workflow module associated with one of the plurality of organizations and configured to perform an organization-specific claims processing workflow. The first customized workflow module communicates, to the workflow engine, organization-specific actions to be performed at the customization points of each of the notice, investigation, recovery, and resolution workflows. The first customized workflow module also requests the workflow engine to perform the normalized claims processing workflow. The workflow engine performs the notice workflow preconditions; the organization-specific actions at the notice workflow customization points; the investigation workflow preconditions; the organization-specific actions at the investigation workflow customization points; the recovery workflow preconditions; the organization-specific actions at the recovery workflow customization points; the resolution workflow preconditions; and the organization-specific actions at the resolution workflow customization points.

Certain embodiments of the present disclosure may provide one or more technical advantages. For example, a universal back office workflow may provide a common workflow framework available to multiple lines of business. The framework may include predefined customization points. Each line of business may implement their specific front end workflow based on the common workflow framework by incorporating logic specific to that line of business into the predefined customization points. Consolidating workflows across multiple lines of business into a universal back office workflow enables consistent and predictable processing of similar workflows across multiple lines of business. Additionally, when business rules change, a business analyst may quickly and consistently update a workflow across multiple lines of business by simply updating the common workflow framework. A technical advantage of one embodiment includes reducing an amount of computing resources used for each line of business's front end systems because the front end systems do not contain duplicated application business logic. Common application business logic may be consolidated in the common workflow framework.

Other technical advantages of the present disclosure will be readily apparent to one skilled in the art from the following figures, descriptions, and claims. Moreover, while specific advantages have been enumerated above, various embodiments may include all, some, or none of the enumerated advantages.

### BRIEF DESCRIPTION OF THE DRAWINGS

For a more complete understanding of the present disclosure and for further features and advantages thereof, reference is now made to the following description taken in conjunction with the accompanying drawings, in which:

FIG. 1 illustrates a block diagram of an example system for implementing universal back office workflows based on a normalized workflow abstraction, according to a particular embodiment;

FIG. 2 illustrates an example method of performing a universal back office workflow based on a normalized workflow abstraction, according to a particular embodiment; and

FIGS. 3A-3C illustrate a flowchart of a particular example method of performing a universal back office workflow based on a normalized workflow abstraction, according to a particular embodiment.

### DETAILED DESCRIPTION

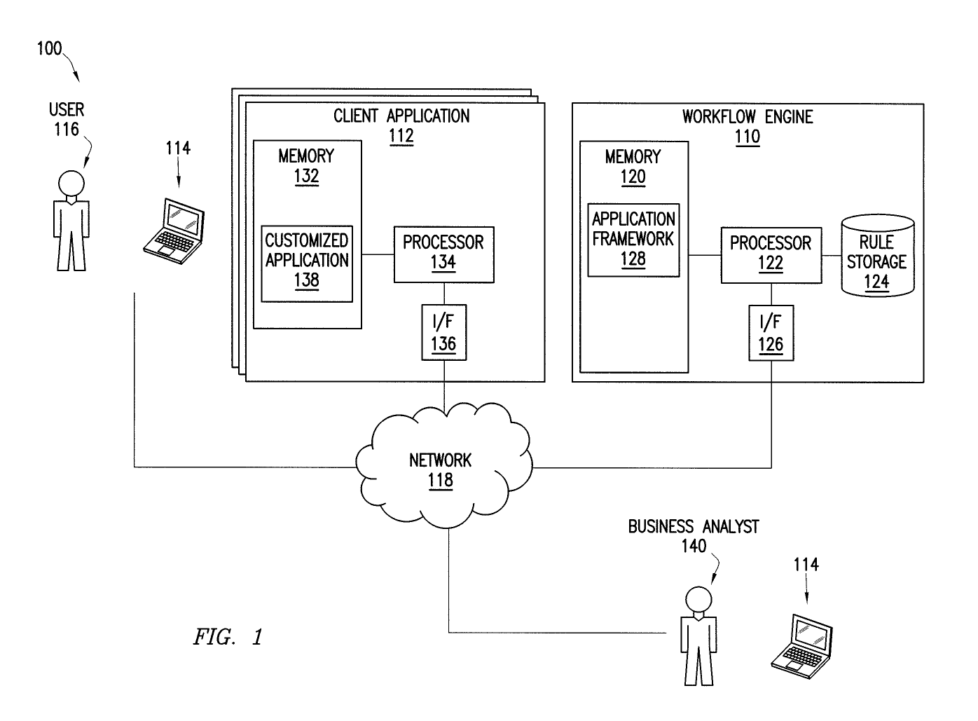

Embodiments of the present disclosure and its advantages are best understood by referring to FIGS. 1-3C, like numerals being used for like and corresponding parts of the various drawings.

A business analyst may consolidate workflows from multiple lines of business (i.e., organization-specific workflows) by generating a normalized workflow abstraction. A business analyst may generate a normalized workflow abstraction by analyzing each organization-specific workflow to identify commonalities among them. For example, a business analyst may analyze the particular steps of each organization-specific workflow, the ordering of those steps, the timing of those steps, and the logic connecting one step to the next. The business analyst may then generate a normalized workflow abstraction by determining a common set of steps, ordering, timing, and/or logic that satisfies the business requirements of each line of business. For portions of a line of business's workflow that are specific to that line of business, the normalized workflow abstraction may define customization points where each line of business may add customized functionality. The normalized workflow abstraction may also include tollgates, or synchronization points, where multiple and concurrent activities of one step may complete before the workflow proceeds to the next step.

In particular embodiments, the normalized workflow abstraction may be implemented in software as common workflow framework available to each line of business. Each line of business may implement their organization-specific workflow based on the common workflow framework by incorporating logic specific to that line of business into predefined customization points.

In particular embodiments, a financial institution may perform a claims processing workflow across multiple lines of business (e.g., credit card products, debit card products, and checking products). The claims processing workflows of all three product lines may be analyzed to determine a normalized workflow abstraction. For example, the normalized workflow abstraction may include the following four phases: notice, investigation, recovery, and resolution, in that order. The notice phase may comprise workflow actions associated with initiating the claims process, such as receiving notice of the claims, determining whether a consumer will receive provisional credit, reporting the claim to card associations, requesting documentation, etc. The investigation phase may include workflow actions such as initiating an auto-chargeback against a merchant. The recovery phase may include workflow actions such as evaluating chargeback documentation and/or arbitration or compliance proceedings. The resolution phase may include workflow actions such as reconciling accounting entries and/or sending letters or statements in accordance with government or industry regulations. Each phase may include a common set of preconditions followed by customization points. The customization points may enable the individual lines of business to augment the normalized workflow abstraction with organization-specific behavior.

One or more tollgates may synchronize workflow actions between phases. For example, a tollgate may be provided between the notice phase and the investigation phase. As a particular example, if a consumer disputes multiple transactions in a single claim, a tollgate may require the notice phase requirements related to all disputed transactions to complete before the claims processing workflow continues to the investigation phase. Front end, organization-specific software systems for claims processing may be implemented using a common workflow framework based on the normalized workflow abstraction.

FIG. 1 illustrates a block diagram of an example system for implementing universal back office workflows based on a normalized workflow abstraction, according to a particular embodiment. System 100 may include workflow engine 110, one or more client applications 112, one or more user devices 114 associated with one or more users 116, and one or more business analysts 140. Network 118 may communicably couple workflow engine 110, client applications 112, and user devices 114. In general, client application 112 provides a front end for user 116 to perform an organization-specific workflow supported by workflow engine 110. Workflow engine 110 may include a common workflow framework comprising application business logic to execute portions of a workflow common across multiple lines of business. Client applications 112 may include business application logic customized to a single line of business and may interact with the common workflow framework of workflow engine 110 to provide the front end to user 116.

Workflow engine 110 may refer to any back end system for performing a particular workflow and may include memory 120, processor 122, rule storage 124, and interface 126. In some embodiments, workflow engine 110 may refer to any suitable combination of hardware and/or software implemented in one or more modules to process data and provide the described functions and operations. In some embodiments, the functions and operations described herein may be performed by a pool of workflow engines 110. In general, workflow engine 110 sends/receives information associated with a workflow to/from client application 112.

Workflow engine 110 provides a normalized workflow abstraction through a common workflow framework. In particular embodiments, a normalized workflow abstraction may represent portions of a workflow common across multiple lines of business. For example, a normalized workflow abstraction may represent a common set of steps, ordering, timing, and/or logic to perform a particular workflow.

Workflow engine 110 may include common application business logic associated with a particular workflow. In some embodiments, the common application business logic associated with a particular workflow is maintained as one or more business logic rules stored in rule storage 124. In some embodiments, processor 122 executes business application logic stored in memory 120. An advantage of workflow engine 110 is that common application business logic may be stored in a format that can be understood by business analyst 140. In some embodiments, a business analyst may manage the common application business rules independently from client applications 112. Managing common application business rules outside of client applications 112 may enable an organization to more quickly and easily modify a workflow without involving application programmers. Managing a store of common application business rules in a central location may also facilitate regulatory compliance through simplified auditing of application business rules.

Memory 120 may refer to any suitable device capable of storing and facilitating retrieval of data and/or instructions. Examples of memory 120 include computer memory (for example, Random Access Memory (RAM) or Read Only Memory (ROM)), mass storage media (for example, a hard disk), removable storage media (for example, a Compact Disk (CD) or a Digital Video Disk (DVD)), database and/or network storage (for example, a server), and/or or any other volatile or non-volatile, non-transitory computer-readable memory devices that store one or more files, lists, tables, or other arrangements of information. Although FIG. 1 illustrates memory 120 as internal to workflow engine 110, memory 120 may be internal or external to workflow engine 110, depending on particular implementations. Also, memory 120 may be separate from or integral to other memory devices to achieve any suitable arrangement of memory devices for use in system 100.

Memory 120 is generally operable to store one or more common workflow frameworks 128. Common workflow framework 128 generally refers to logic, rules, algorithms, code, tables, and/or other suitable instructions for performing a particular business workflow. In some embodiments, common workflow framework 128 may perform a particular workflow based on application business rules stored in rule storage 124. In particular embodiments, common workflow framework 128 may represent a normalized workflow abstraction. In particular embodiments, common workflow framework 128 may partition a workflow into one or more common phases. In some embodiments, tollgates may separate some phases. A phase may include common preconditions applicable to all users of the workflow. In some embodiments, common workflow framework 128 may provide customization points associated with a phase. A customization point may enable client application 112 to perform actions customized to a particular line of business within the workflow. In some embodiments, common workflow framework 128 may facilitate a claims processing workflow such as the financial institution's claims processing workflow example described above. In particular embodiments, common workflow framework 128 may facilitate any workflow applicable to an organization's business.

Common workflow framework 128 processes requests/responses from/to client application 112. In particular embodiments, common workflow framework 128 may provide an Application Programming Interface (API) to interact with client applications 112. The API may comprise a message based API, a shared memory based API, a remote procedure call API, or any other suitable interface to enable communication between common workflow framework 128 and client application 112. In particular embodiments, an API may provide customization points within common workflow framework 128 through callbacks, notifications, or any other suitable method.

Processor 122 is communicably coupled to memory 120. Processor 122 is generally operable to execute common workflow framework 128 stored in memory 120 to perform a particular business workflow. Processor 122 may comprise any suitable combination of hardware and software to execute instructions and manipulate data to perform the described functions for workflow engine 110. In some embodiments, processor 122 may include, for example, one or more computers, one or more central processing units (CPUs), one or more microprocessors, one or more applications, and/or other logic.

Rule storage 124 is communicably coupled to processor 122. In some embodiments, rule storage 124 may refer to any suitable device capable of storing and facilitating retrieval of data and/or instructions, such as application business rules. Examples of rule storage 124 include computer memory (for example, Random Access Memory (RAM) or Read Only Memory (ROM)), mass storage media (for example, a hard disk), removable storage media (for example, a Compact Disk (CD) or a Digital Video Disk (DVD)), database and/or network storage (for example, a server), and/or or any other volatile or non-volatile, non-transitory computer-readable memory devices that store one or more files, lists, tables, or other arrangements of information. Rule storage 124 may store any business application rules utilized by workflow engine 110.

As a particular example, a financial institution may implement a claims processing workflow using workflow engine 110. Rule storage 124 may include common application business rules related to tasks such as initiating claims, assigning claims, investigating claims, approving claims, reimbursing claims, arbitrating claims, etc. Rule storage 124 may include application business rules for complying with regulatory restrictions, which may vary by geographic location. Rule storage 124 may include business application rules for setting thresholds that trigger fraud alerts. When business rules, regulatory restrictions, or fraud detection methods change, a business analyst may quickly update workflow engine 110 to reflect the changes.

In some embodiments, interface 126 (I/F) is communicably coupled to processor 122 and may refer to any suitable device operable to receive input for workflow engine 110, send output from workflow engine 110, perform suitable processing of the input or output or both, communicate to other devices, or any combination of the preceding. Interface 126 may include appropriate hardware (e.g. modem, network interface card, etc.) and software, including protocol conversion and data processing capabilities, to communicate through network 118 or other communication system that allows workflow engine 110 to communicate to other components of system 100. Interface 126 may include any suitable software operable to access data from various devices such as user devices 114, client application 112, and/or workflow engine 110. Interface 126 may include any suitable software operable to transmit data to various devices such as user devices 114, client application 112, and/or workflow engine 110. Interface 126 may include one or more ports, conversion software, or both.

Client applications 112 may refer to any front end systems for performing a particular workflow and may include memory 132, processor 134, and interface 136. In some embodiments, client application 112 may refer to any suitable combination of hardware and/or software implemented in one or more modules to process data and provide the described functions and operations. In general, client application 112 provides a front end interface for users 116 to interact with a back end system, such as workflow engine 110, to perform a particular workflow. Client application 112 sends/receives information associated with a workflow to/from users 116 on the front end and to/from workflow engine 110 on the back end.

In particular embodiments, multiple lines of business within an organization may implement their own organization-specific client application 112 to perform a particular workflow. Client application 112 may provide a customized interface to users 166 for interacting with the normalized workflow abstraction provided by workflow engine 110. In particular embodiments, client application 112, through customization points provided by workflow engine 110, may enable user 116 to perform an organization-specific workflow.

Memory 132 may refer to any suitable device capable of storing and facilitating retrieval of data and/or instructions, similar to memory 120 described above. Although FIG. 1 illustrates memory 132 as internal to client application 112, memory 132 may be internal or external to client application 112, depending on particular implementations. Also, memory 132 may be separate from or integral to other memory devices to achieve any suitable arrangement of memory devices for use in system 100. Memory 132 is generally operable to store customized application 138.

Customized application 138 generally refers to logic, rules, algorithms, code, tables, and/or other suitable instructions for performing an organization-specific workflow. Customized application 138 interacts with workflow engine 110, which provides the common portions of a particular workflow to users 116. In particular embodiments, customized application 138 also includes logic, rules, algorithms, code, tables, and/or other suitable instructions to provide customized portions of a particular workflow to users 116.

Processor 134 is communicably coupled to memory 132. Processor 134 is generally operable to execute a workflow associated with client application 112 by executing components such as customized application 138. Processor 122 may comprise any suitable combination of hardware and software to execute instructions and manipulate data to perform the described functions for client application 112. In some embodiments, processor 122 may include, for example, one or more computers, one or more central processing units (CPUs), one or more microprocessors, one or more applications, and/or other logic.

In some embodiments, interface 136 (I/F) is communicably coupled to processor 134 and may refer to any suitable device operable to receive input for client application 112, send output from client application 112, perform suitable processing of the input or output or both, communicate to other devices, or any combination of the preceding. Interface 136 may include appropriate hardware and software as described above in reference to interface 126.

User devices 114 may refer to any devices that enable users 116 to interact with client application 112 or business analysts 140 to interact with workflow engine 110. In some embodiments, user device 114 may include a computer, workstation, telephone, Internet browser, electronic notebook, Personal Digital Assistant (PDA), pager, or any other suitable device (wireless, wireline, or otherwise), component, or element capable of receiving, processing, storing, and/or communicating information with other components of system 100. User device 114 may also comprise any suitable user interface such as a display, microphone, keyboard, or any other appropriate terminal equipment. System 100 may comprise any number and combination of user devices 114.

In some embodiments, user 116 may refer to an employee of an organization or a financial institution. As an example, a bank's claim representative may use user device 114 to initiate a claim on behalf of a bank customer. In some embodiments, user 116 may be a consumer or someone external to an organization.

In some embodiments, user device 114 may include a graphical user interface (GUI). The GUI is generally operable to tailor and filter data entered by and presented to user 116. The GUI may provide user 116 with an efficient and user-friendly presentation of screens associated with a business application workflow. The GUI may comprise a plurality of displays having interactive fields, pull-down lists, and buttons operated by user 116. The GUI may include multiple levels of abstraction including groupings and boundaries. The term GUI may be used in the singular or in the plural to describe one or more GUIs and each of the displays of a particular GUI.

In some embodiments, business analyst 140 may refer to any employee of an organization, or consultant to an organization, or any other person who understands business requirements relevant to a particular workflow. Business analyst 140 may be able to analyze multiple workflows across multiple lines of business to generate a normalized workflow abstraction. Business analyst 140 may generate a normalized workflow abstraction by analyzing each workflow to identify commonalities among them. For example, business analyst 140 may analyze the particular steps of each workflow, the ordering of those steps, the timing of those steps, and the logic connecting one step to the next. Business analyst 140 may then generate a normalized workflow abstraction by determining a common set of steps, ordering, timing, and/or logic that satisfies the business requirements of each line of business.

In certain embodiments, network 118 may refer to any interconnecting system capable of transmitting audio, video, signals, data, messages, or any combination of the preceding. Network 118 may include all or a portion of a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, or any other suitable communication link, including combinations thereof.

Although workflow engine 110, client application 112, and user device 114 are illustrated in FIG. 1 as separate components of system 100 connected by network 118, particular embodiments may integrate some or all components. For example, in particular embodiments client application 112 may be integrated with workflow engine 110. As a particular example, client application 112 may comprise a web server hosted by workflow engine 110. In particular embodiments, client application 112 may be integrated with user device 114. For example, client application 112 may comprise a mobile app executable on mobile user device 114. In particular embodiments, system 100 may comprise any suitable combination of user device 114, client application 112, and workflow engine 110.

Although workflows have been described as common or customized across multiple lines of business, or as organization-specific, workflows may be grouped in any suitable manner. For example, multiple, yet similar, workflows may exist within the same line of business, or commonalities may exist between workflows of the same line of business across multiple subsidiary organizations.

Organization may refer a business, an enterprise, an institution, a non-profit, or any other organization that might perform workflows. In some contexts, organization may refer to a sub-group of a larger organization, such as a particular line of business or department within a larger organization. For example, organization may refer to lines of business within a financial institution (e.g., credit card products, debit card products, checking products, etc.).

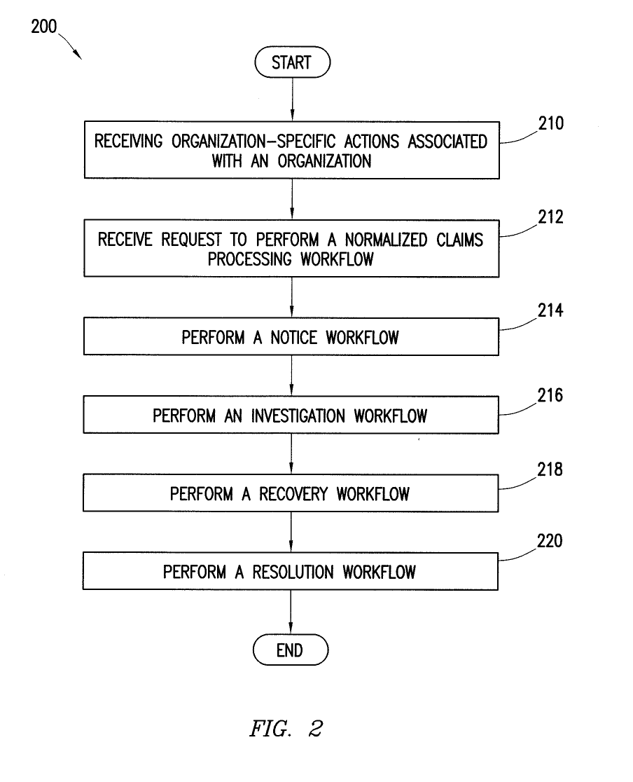

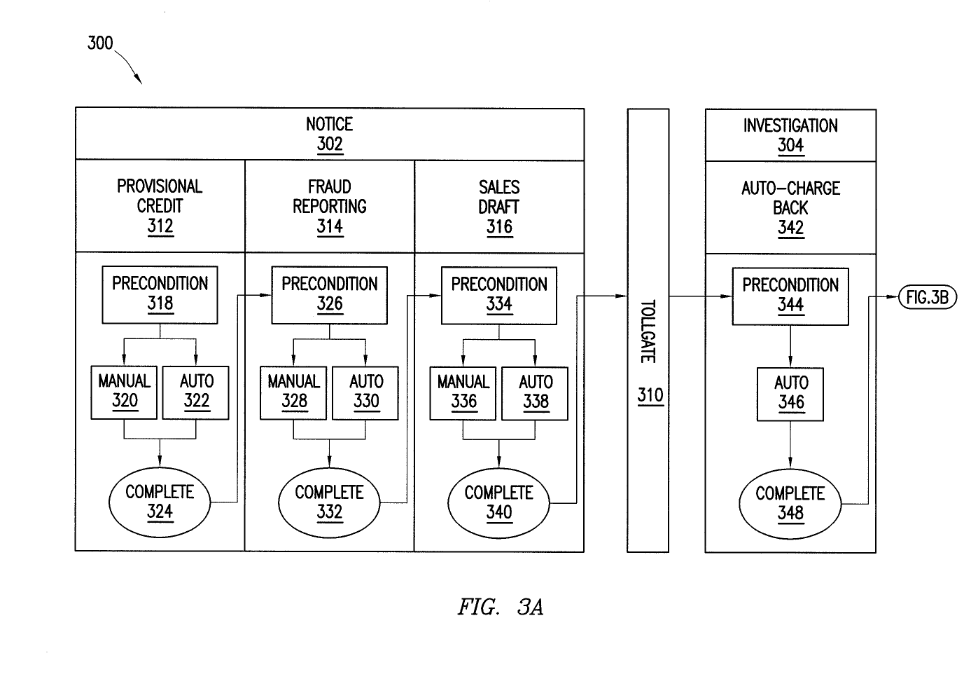

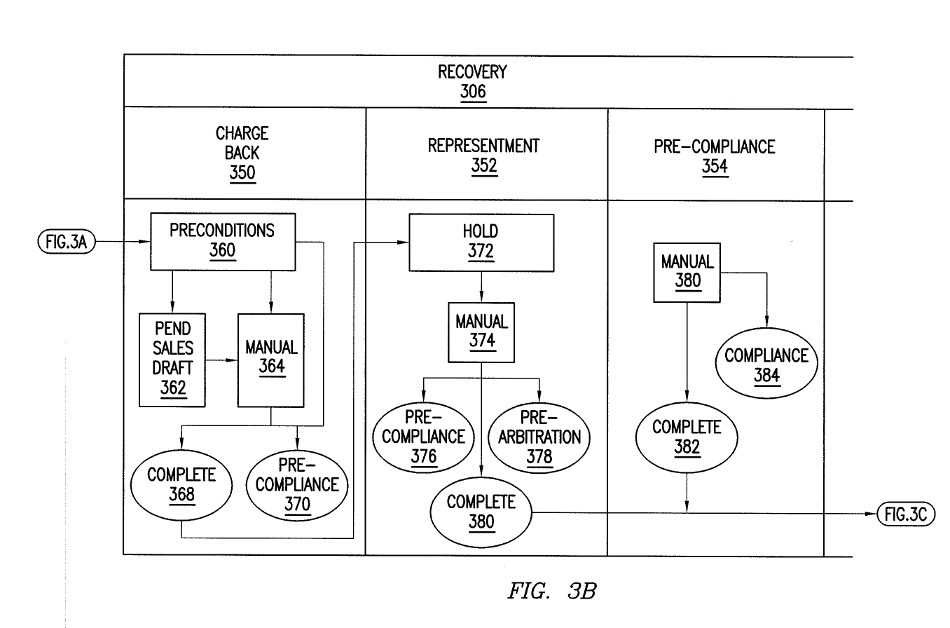

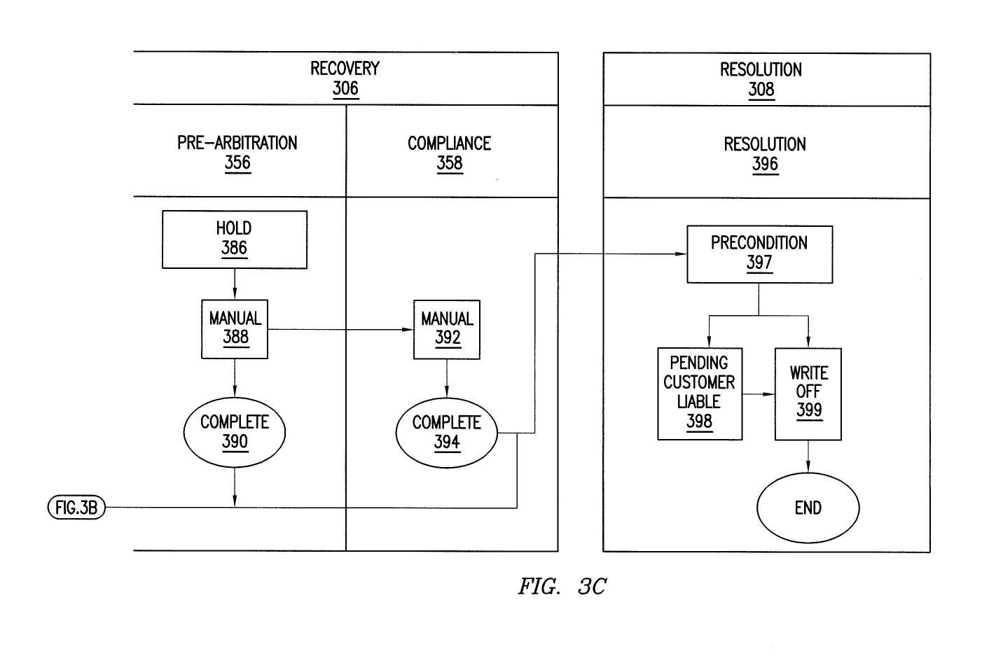

In operation, user 116 interacts with client application 112 via user device 114 to perform a particular business application workflow. In particular embodiments, workflow engine 110 provides a common application framework to client application 112. Workflow engine 110 performs the portion of a workflow common across multiple lines of business. In particular embodiments, client application 112 performs the portion of a workflow specific to a particular line of business. An example of a particular embodiment of system 100 in operation is described below with reference to FIGS. 2 and 3A-C.

Certain advantages described above may be realized by a common workflow framework available to multiple lines of business. Consolidating workflows across multiple lines of business into a universal back office workflow enables consistent and predictable processing of similar workflows across multiple lines of business. Additionally, when business rules change, a business analyst may quickly and consistently update a workflow across multiple lines of business by simply updating the common workflow framework. A technical advantage of one embodiment includes reducing an amount of computing resources used for each line of business's front end systems because the front end systems do not contain duplicated application business logic. Common application business logic may be consolidated in the common workflow framework.

FIG. 2 illustrates an example method of performing a universal back office workflow based on a normalized workflow abstraction, according to a particular embodiment. In particular embodiments, one or more steps of method 200 may be performed by components of system 100 of FIG. 1.

At step 210, organization-specific actions associated with an organization are received. In particular embodiments, workflow engine 110 receives organization-specific actions associated with an organization from client application 112.

An organization may refer to sub-groups within a larger organization, such as a department or product line within an enterprise. In particular embodiments, an organization may refer to a credit card, a debit card, or a checking product line within a financial institution.

Organization-specific actions may refer to actions associated with a particular organization, such as a particular product line. For example, credit card and debit card product lines may each perform a disputed transaction claims processing workflow. Each product line may initiate the claim process by receiving a complaint from a customer and each product line may grant the customer provisional credit. The credit card product line may automatically grant the provisional credit. The debit card product line, however, may manually determine whether to grant the provisional credit. In this example, determining whether to grant the provisional credit automatically or manually represents an organization-specific action.

In particular embodiments, client application 112 sends the organization-specific actions to workflow engine 110. In some embodiments, client application 112 may provide callback functions to workflow engine 110. A callback function may comprise a handle or pointer to a portion of computer logic for performing the organization-specific action.

In some embodiments, client application 112 may register with workflow engine 110 and workflow engine 110 may notify application 112 when to perform organization-specific actions. In particular embodiments, registration and/or notification may be message based.

In some embodiments, client application 112 may send workflow engine 110 values for known thresholds. The threshold values may cause workflow engine 110 to perform different actions based on the value. For example, workflow engine 110 may evaluate a dollar amount threshold to determine whether to grant a customer provisional credit. A debit card product line may set the dollar amount threshold to $0, resulting in workflow engine 110 granting provisional credit for all claims. A credit card product may set the threshold value to $5,000, resulting in a grant of provisional credit for only some claims. In some embodiments, client application 112 may use any suitable method, or any combination of methods, to communicate organization-specific actions to workflow engine 110.

At step 212, a request to perform a normalized claims processing workflow is received. In particular embodiments, workflow engine 110 receives a request to perform a normalized claims processing workflow from client application 112. In particular embodiments, client application 112 may invoke an API provided by workflow engine 110. In particular embodiments, client application 112 may send a message to workflow engine 110. In particular embodiments, client application 112 may use any suitable method, or combination of methods, to communicate with workflow engine 110.

In particular embodiments, the normalized claims processing workflow comprises a notice workflow that initiates processing of a claim, an investigation workflow that investigates the claim, a recovery workflow that recovers a value associated with the claim, and a resolution workflow that concludes processing of a claim.

At step 214, the notice workflow is performed. In particular embodiments, workflow engine 110 performs workflow actions associated with initiating a claim. The actions may include receiving a new claim request from a customer, granting provisional credit to the customer, and requesting documentation from a merchant In particular embodiments, performing the notice workflow comprises performing notice workflow preconditions and performing organization-specific actions at the notice workflow customization points.

In particular embodiments, performing a precondition refers to performing actions common among multiple organizations. For example, credit card and debit card product lines may both ask a customer to provide transaction details regarding a disputed transaction. This workflow action is common among both organizations and may be performed as a precondition.

In particular embodiments, credit card and debit card product lines may also perform organization-specific workflow actions, such as determining whether to grant provisional credit automatically or manually. These organization-specific workflow actions may be performed at customization points within the notice workflow. The actions to be performed at the customization points were configured in previous step 210.

At step 216, the investigation workflow is performed. In particular embodiments, workflow engine 110 performs workflow actions associated with investigating a claim. The actions may include requesting evidence related to a disputed transaction from a customer or merchant. In particular embodiments, the actions may include initiating an auto-chargeback procedure. In particular embodiments, performing the investigation workflow comprises performing investigation workflow preconditions and performing organization-specific actions at the investigation workflow customization points. In particular embodiments, customization points may include determining whether initiating an auto-chargeback is necessary for the disputed transaction.

At step 218, the recovery workflow is performed. In particular embodiments, workflow engine 110 performs workflow actions associated with recovering a value associated with a claim. The actions may include evaluating chargeback documentation and/or arbitration or compliance proceedings. In particular embodiments, performing the recovery workflow comprises performing recovery workflow preconditions and performing organization-specific actions at the recovery workflow customization points.

At step 220, the resolution workflow is performed. In particular embodiments, workflow engine 110 performs workflow actions associated with concluding the claim processing. The actions may include reconciling accounting entries and/or sending letters or statements in accordance with government or industry regulations. In particular embodiments, performing the resolution workflow comprises performing resolution workflow preconditions and performing organization-specific actions at the resolution workflow customization points.

Although not illustrated in FIG. 2, one or more tollgates may synchronize workflow actions between steps 214, 216, 218, and/or 220. For example, a tollgate may be provided between the notice workflow at step 214 and the investigation workflow at step 216. In a particular embodiment, notice workflow may comprise multiple sub-tasks within the workflow. A tollgate may require all sub-tasks of the notice workflow to complete before method 200 continues to the investigation workflow at step 216. For example, a consumer may dispute multiple transactions in a single claim. A tollgate may require the notice workflow sub-tasks related to all disputed transactions to complete before method 200 continues to the investigation workflow at step 216.

Although each of the notice, investigation, recovery, and resolution workflows is described above as performing common preconditions followed by customization points, in particular embodiments, any workflow may perform any number of preconditions followed by any number of customization points, or any number of precondition and customization point cycles.

Although an action common across multiple organizations is referred to as a precondition, the term precondition is not meant to specify any particular order. In some embodiments, customization points may come before preconditions.

FIGS. 3A-3C illustrate a flowchart of a particular example method of performing a universal back office workflow based on a normalized workflow abstraction, according to a particular embodiment. In particular embodiments, one or more steps of method 300 may be performed by components of system 100 of FIG. 1. In this example, the workflow represents a financial organization's claims processing workflow for processing disputed transactions.

According to a particular embodiment, a financial institution may perform a claims processing workflow across multiple product lines (e.g., credit card products, debit card products, and checking products). Each workflow may be referred to as an organization-specific workflow. A normalized workflow abstraction for the three product lines may include the following four top-level phases: notice 302, investigation 304, recovery 306, and resolution 308. One or more tollgates 310 may be included between any suitable phases, such as between notice 302 and investigation 304.

During notice 302, method 300 receives a claim from a customer and begins processing the claim. In particular embodiments, notice 302 may include the following three sub-phases: provisional credit 312, fraud reporting 314, and sales draft 316. Each sub-phase may include preconditions and customization points.

In particular embodiments, sub-phase provisional credit 312 determines whether the consumer is entitled to receive provisional credit. The method may evaluate preconditions 318. Preconditions refer to logic in the normalized portion of the workflow that may be common across multiple organizations. In some embodiments, preconditions 318 may include the timeframe in which the customer submitted the dispute and/or the dollar amount of the dispute. Evaluation of preconditions 318 may determine whether a provisional credit is processed manually at step 320 or automatically at step 324. In some embodiments, customization points may include thresholds associated with the timeframe in which the customer submitted the dispute and/or the dollar amount of the dispute. A credit card workflow may configure different thresholds than a checking workflow. For example, a credit card workflow may set a threshold of sixty days associated with the timeframe in which the customer submitted the dispute and/or a dollar amount of $5,000 associated with the dispute. Provisional credit for disputed transactions submitted in less than sixty days and for an amount under $5,000 may automatically be processed. Other transactions may be manually processed. A checking workflow, however, may manually process all provisional credits. To accomplish this, checking workflow may configure a dollar amount threshold of $0. After determining whether to grant provisional credit, the sub-phase is complete at step 324.

In particular embodiments, the next sub-phase is fraud reporting 314. Sub-phase fraud reporting 314 determines whether a disputed transaction is reported to an industry or card association (e.g., MasterCard, Visa, Discover, etc.). In some embodiments, preconditions 326, such as the amount of transaction, may determine whether fraud reporting is performed manually 326 or automatically 328. Different product lines may customize fraud reporting 314 by customizing thresholds associated with preconditions 326. After performing fraud reporting, if determined to be necessary, the sub-phase is complete at step 332.

In particular embodiments, the next sub-phase is sales draft 316. Sub-phase sales draft 316 determines whether a claims representative should request transaction documents (e.g., sales drafts, receipts, etc.) related to the disputed transaction. In some embodiments, preconditions 334, such as the amount of transaction, may determine whether transaction documents are requested manually 336 or automatically 338. Different product lines may customize sales draft 316 by customizing thresholds associated with preconditions 334. After requesting transaction documents, if determined to be necessary, the sub-phase is complete at step 340.

In particular embodiments, method 300 may include tollgate 310 between notice 302 and investigation 304. Tollgate 310 may represent a synchronization point. In particular embodiments, notice 302 may include multiple disputed transactions. Performing sub-phases 312, 314, and 316 may take longer for some disputed transactions than others. For example, a disputed transaction that follows a fraud reporting 314 manual 328 path may take longer than a disputed transaction that follows a fraud reporting 314 automatic 330 path. In particular embodiments, tollgate 310 enables notice 302 to complete for all disputed transactions before method 300 continues to investigation 304. Particular embodiments may include tollgate 310 between sub-phases.

During investigation 304, method 300 investigates the disputed transaction. In particular embodiments, investigation 304 may include sub-phase auto-chargeback 342. In particular embodiments, sub-phase auto-chargeback 342 determines whether a merchant (or the merchant's bank) is debited for the disputed transaction. Sub-phase auto-chargeback 342 may evaluate preconditions 344. In some embodiments, preconditions 344 may include a dollar amount of the dispute and/or a transaction type associated with the dispute. In some embodiments, preconditions 344 may include a flag indicating whether to perform an auto-chargeback for all disputed transactions. Evaluation of preconditions 344 may determine whether a chargeback is automatically initiated at step 346. In some embodiments, organization-specific workflows may customize sub-phase auto-chargeback 342 by configuring dollar amounts, transaction types, and/or flags to control the outcome of preconditions 344. A credit card workflow may configure different thresholds than a debit card workflow. For example, a credit card workflow may perform auto-chargeback for all disputed transactions. A debit card workflow, however, may distinguish between point-of-sale (POS) transactions and automated teller machine (ATM) transactions and may not perform auto-chargeback for certain ATM transactions. After determining whether to perform auto-chargeback, the sub-phase is complete at step 348.

During recovery 306, method 300 attempts to recover a value associated with the disputed transaction. In particular embodiments, recovery 306 may include the following five sub-phases: chargeback 350, representment 352, pre-compliance 354, pre-arbitration 356, and compliance 358. Each sub-phase may include preconditions and customization points.

In particular embodiments, sub-phase chargeback 350 determines whether the auto-chargeback initiated during investigation 304 may be completed. The method may evaluate preconditions 360. In some embodiments, preconditions 360 may include processing of fee collection/dispersement, accounting of partial-credits or over-credits, evaluating a chargeback reversal, and/or any other suitable precondition for processing chargebacks. Evaluation of preconditions 360 may determine whether a chargeback is processed manually at step 364 or whether the sub-phase may wait to evaluate received disputed transaction information, such as sales drafts, at step 324. In some embodiments, a chargeback is processed and the sub-phase is complete at step 324. In some embodiments, recovery 306 continues to sub-phase representment 352. In some embodiments, evaluation of preconditions 360 and/or manual processing 364 may determine, at step 370, that recovery 306 continues to sub-phase pre-compliance 354.

In particular embodiments, sub-phase representment 352 determines whether a merchant may successfully rebut a disputed transaction. In some embodiments, sub-phase representment 352 may wait for a merchant to submit evidence at step hold 372. After manually evaluating the merchant's evidence at step 374, sub-phase representment 352 may determine one of the following: the chargeback is complete at step 380, the next sub-phase includes pre-compliance 254 at step 376, or the next sub-phase includes pre-arbitration 256 at step 378. Completion of sub-phase representment 352 at step 380 also completes recovery 306 and method 300 continues to resolution 308.

In particular embodiments, sub-phase pre-compliance 354 enables representatives of a card issuer and representatives of a merchant (or the merchant's bank) to attempt to resolve the disputed transaction where there is a violation of a card association's operating regulations (e.g., requested transaction information not received, compromised data, incorrect currency conversion, delayed services, etc.). If pre-compliance negotiations are successful, sub-phase pre-compliance 354 may complete at step 382. If pre-compliance negotiations are unsuccessful, sub-phase pre-compliance 354 may continue to compliance 358 at step 384. Completion of sub-phase pre-compliance 354 at step 382 also completes recovery 306 and method 300 continues to resolution 308.

In particular embodiments, sub-phase pre-arbitration 356 enables representatives of a card issuer and representatives of a merchant (or the merchant's bank) to attempt to resolve the disputed transaction outside the chargeback process, but prior to arbitration. In some embodiments, sub-phase pre-arbitration 356 may wait for submission of additional evidence at step hold 386. After manually evaluating additional evidence at step 388, sub-phase pre-arbitration 356 may determine that pre-arbitration 356 is complete at step 390 or that the next sub-phase includes compliance 258. Completion of sub-phase pre-arbitration 356 at step 390 also completes recovery 306 and method 300 continues to resolution 308.

In particular embodiments, sub-phase compliance 358 requests a formal determination from a card association regarding a disputed transaction. After manually receiving the card association's determination at step 392, sub-phase compliance 358 is complete at step 394.

During resolution 308, method 300 concludes processing of the disputed transaction. In particular embodiments, resolution 308 may include sub-phase resolution 396. In particular embodiments, sub-phase resolution 396 reconciles accounting entries associated with the disputed transaction and sends letters or statements in accordance with government or industry regulations. In particular embodiments, preconditions 397 may include evaluating results of prior phases such as results of investigation 304 and/or recovery 306. If the customer is found liable for the disputed transaction at pending customer liable 398, in particular embodiments, resolution 308 may reverse a chargeback performed in an earlier phase. In particular embodiments, resolution 308 may perform accounting write-offs at writeoff 399. At the end of resolution 308, claims processing for the disputed transaction is complete.

The steps of method 200 are given as example combinations of workflow actions for performing claims processing. Many of the steps may be performed in a different order or repeated where appropriate. Additionally, one of skill in the art will recognize other combinations of steps are possible without departing from the scope of the present disclosure.

Certain embodiments of the present disclosure may provide one or more technical advantages. For example, a universal back office workflow may provide a common workflow framework available to multiple lines of business. The framework may enable each line of business to implement their organization-specific workflow based on the common workflow framework by incorporating organization-specific logic into predefined customization points. Consolidating workflows across multiple lines of business into a universal back office workflow enables consistent and predictable processing of similar workflows across multiple lines of business. Additionally, when business rules change, a business analyst may quickly and consistently update a workflow across multiple lines of business by simply updating the common workflow framework. A technical advantage of one embodiment includes reducing an amount of computing resources used for each line of business's front end systems because the front end systems do not contain duplicated application business logic.

Although the present disclosure has been described with several embodiments, a myriad of changes, variations, alterations, transformations, and modifications may be suggested to one skilled in the art, and it is intended that the present disclosure encompass such changes, variations, alterations, transformations, and modifications as fall within the scope of the appended claims.

What is claimed is:

1. A system, comprising:
a memory operable to store instructions;
a processor communicably coupled to the memory and operable to execute the instructions, wherein the instructions comprise:
a workflow engine for performing a normalized claim processing workflow normalized over a plurality of organizations, wherein:
the normalized claim processing workflow comprises:
a notice workflow that initiates processing of a claim;
an investigation workflow that investigates the claim;
a recovery workflow that recovers a value associated with the claim; and
a resolution workflow that concludes processing of the claim;
the notice, investigation, recovery, and resolution workflows each comprise preconditions common among the plurality of organizations, the preconditions configured to perform a portion of the normalized claims processing workflow common among the plurality of organizations; and
the notice, investigation, recovery, and resolution workflows each comprise customization points, the customization points configured to perform organization-specific workflow actions;
a first customized workflow module associated with one of the plurality of organizations and configured to perform an organization-specific claims processing workflow by performing operations comprising:
communicating, to the workflow engine, organization-specific actions to be performed at the customization points of each of the notice, investigation, recovery, and resolution workflows;
requesting the workflow engine to perform the normalized claims processing workflow;
the workflow engine configured to perform operations comprising:
performing the notice workflow preconditions;
performing the organization-specific actions at the notice workflow customization points;
performing the investigation workflow preconditions;
performing the organization-specific actions at the investigation workflow customization points;
performing the recovery workflow preconditions;
performing the organization-specific actions at the recovery workflow customization points;
performing the resolution workflow preconditions; and
performing the organization-specific actions at the resolution workflow customization points.

2. The system of claim 1, further comprising a tollgate between a first one of the notice, investigation, recovery, and resolution workflows and a second one of the notice, investigation, recovery, and resolution workflows, wherein the tollgate requires a plurality of sub-tasks associated with one of the notice, investigation, recovery, or resolution workflows to complete before performing another one of the notice, investigation, recovery, or resolution workflows.

3. The system of claim 1, wherein communicating workflow actions to be performed at the customization points comprises specifying threshold values applicable to the organization-specific workflow.

4. The system of claim 1, wherein communicating workflow actions to be performed at the customization points comprises specifying callback functions applicable to the organization-specific workflow, the callback function specifying logic to be executed by the workflow engine.

5. The system of claim 1, further comprising:
a second customized workflow module associated with a second one of the plurality of organizations and configured to perform a second organization-specific claims processing workflow by performing operations comprising:
communicating, to the workflow engine, second organization-specific actions to be performed at the customization points of each of the notice, investigation, recovery, and resolution workflows;
requesting the workflow engine to perform the normalized claims processing workflow.

6. The system of claim 1, wherein the notice workflow that initiates processing of the claim comprises:
receiving notice of the claim from a customer;
determining whether the customer will receive a provisional credit; and
reporting the claim to a card association.

7. The system of claim 1, wherein the investigation workflow that investigates the claim comprises initiating an auto-chargeback against a merchant.

8. The system of claim 1, wherein the recovery workflow that recovers the value associated with the claim comprises at least one of:
evaluating documentation associated with a chargeback;
initiating a pre-arbitration proceeding; and
initiating a pre-compliance proceeding.

9. The system of claim 1, wherein the resolution workflow that concludes processing of the claim comprises sending letters to a customer or a merchant.

10. A method, comprising:
receiving, at a workflow engine, organization-specific actions associated with a first organization of a plurality of organizations, the organization-specific actions to be performed at customization points of a normalized claim processing workflow normalized over the plurality of organizations; wherein:
the normalized claim processing workflow comprises:
a notice workflow that initiates processing of a claim;
an investigation workflow that investigates the claim;
a recovery workflow that recovers a value associated with the claim; and
a resolution workflow that concludes processing of the claim;
the notice, investigation, recovery, and resolution workflows each comprise preconditions common among the plurality of organizations, the preconditions configured to perform a portion of the normalized claims processing workflow common among the plurality of organizations; and
the notice, investigation, recovery, and resolution workflows each comprise customization points, the customization points configured to perform organization-specific workflow actions;
receiving a request to perform the normalized claims processing workflow;
performing the notice workflow, the performing the notice workflow comprising:
performing the notice workflow preconditions;
performing the organization-specific actions at the notice workflow customization points;
performing the investigation workflow, the performing the investigation workflow comprising:
performing the investigation workflow preconditions;
performing the organization-specific actions at the investigation workflow customization points;
performing the recovery workflow, the performing the recovery workflow comprising:
performing the recovery workflow preconditions;
performing the organization-specific actions at the recovery workflow customization points;
performing the resolution workflow, the performing the resolution workflow comprising:
performing the resolution workflow preconditions; and
performing the organization-specific actions at the resolution workflow customization points.

11. The method of claim 10, wherein:
one of the notice, investigation, recovery, or resolution workflows comprises a plurality of workflow sub-tasks; and
performing one of the notice, investigation, recovery, or resolution workflows comprises performing all of the plurality of workflow sub-tasks before performing another one of the notice, investigation, recovery, or resolution workflows.

12. The method of claim 10, wherein receiving the organization-specific actions to be performed at the customization points of the normalized claim processing workflow comprises receiving threshold values applicable to the organization-specific workflows.

13. The method of claim 10, wherein receiving the organization-specific actions to be performed at the customization points of the normalized claim processing workflow comprises receiving callback functions applicable to the organization-specific workflows, the callback function specifying logic to be executed by the workflow engine.

14. The method of claim 10, further comprising:
receiving, at the workflow engine, organization-specific actions associated with a second organization, the organization-specific actions associated with the second organization to be performed at the customization points of the normalized claim processing workflow.

15. A method, comprising:
associating a first customized workflow module with a workflow engine configured to perform a normalized claim processing workflow normalized over a plurality of organizations, wherein:
the normalized claim processing workflow comprises:
a notice workflow that initiates processing of a claim;
an investigation workflow that investigates the claim;
a recovery workflow that recovers a value associated with the claim; and
a resolution workflow that concludes processing of the claim;
the notice, investigation, recovery, and resolution workflows each comprise preconditions common among the plurality of organizations, the preconditions configured to perform a portion of the normalized claims processing workflow common among the plurality of organizations; and
the notice, investigation, recovery, and resolution workflows each comprise customization points, the customization points configured to perform organization-specific workflow actions; and
the first customized workflow module is associated with a first one of the plurality of organizations and configured to perform a first organization-specific claims processing workflow;
communicating, to the workflow engine, first organization-specific actions to be performed at the customization points of each of the notice, investigation, recovery, and resolution workflows; and
requesting the workflow engine to perform the normalized claims processing workflow.

16. The method of claim 15, further comprising:
associating a second customized workflow module with the workflow engine, wherein the second customized workflow module is associated with a second one of the plurality of organizations and configured to perform a second one of the plurality of organization-specific workflows; and
communicating, to the workflow engine, second organization-specific actions to be performed at the customization points of each of the notice, investigation, recovery, and resolution workflows.

17. The method of claim 15, wherein communicating first organization-specific actions to be performed at the customization points of each of the notice, investigation, recovery, and resolution workflows comprises communicating threshold values applicable to the organization-specific workflows.

18. The method of claim 15, wherein communicating first organization-specific actions to be performed at the customization points of each of the notice, investigation, recovery, and resolution workflows comprises communicating callback functions applicable to the organization-specific workflows, the callback function specifying logic to be executed by the workflow engine.
